(19) United States
(12) Patent Application Publication
(10) Pub. No.: US 2025/0078738 A1
(43) Pub. Date: Mar. 6, 2025

(54) METHOD AND APPARATUS FOR ADJUSTING DISPLAY BRIGHTNESS, AND DISPLAY APPARATUS

(71) Applicants: Chengdu BOE Optoelectronics Technology Co., Ltd., Chengdu, Sichuan (CN); BOE TECHNOLOGY GROUP CO., LTD., Beijing (CN)

(72) Inventors: Lixia SHEN, Beijing (CN); Shuai HOU, Beijing (CN); Tan JING, Beijing (CN)

(21) Appl. No.: 18/294,310

(22) PCT Filed: Sep. 29, 2022
(86) PCT No.: PCT/CN2022/122532

§ 371 Date: Feb. 1, 2024

(51) Int. Cl. G09G 3/3208

(52) U.S. Cl. CPC G09G 3/3208; G09G 2320/0233; G09G 2320/0626; G09G 2320/0673

(57) ABSTRACT

The present disclosure provides a method for adjusting display brightness, an apparatus for adjusting display brightness and a display apparatus, belongs to the field of display technology, and can solve the problem that the waste of bonding points is easily caused and the accuracy of adjustment on the display brightness is influenced due to different types of driving chips provided by different manufacturers. The method for adjusting display brightness includes: acquiring a plurality of first display brightness values input corresponding to a plurality of bonding points of a display panel; converting the plurality of first display brightness values into a plurality of second display brightness values according to a preset mapping relationship, and the plurality of second display brightness values are matched with a gamma adjustment curve; and adjusting the display brightness of the display panel by using the plurality of second display brightness values.

### TECHNICAL FIELD

The present disclosure relates to the field of display technology, and particularly relates to a method for adjusting display brightness, an apparatus for adjusting display brightness and a display apparatus.

### BACKGROUND

An organic light-emitting diode (OLED) is a light-emitting device using an organic solid semiconductor as a light-emitting material, and has a wide application prospect because of its advantages of simple preparation process, low cost, low power consumption, high brightness, wide range of operating temperature, and the like.

In order to ensure uniformity of display brightness of an OLED display panel, the display brightness of the display panel is often desired to be adjusted, for example, by a gamma adjustment. On the present market, different manufacturers provide different types of driving chips, and the most common difference is the difference in the number of bonding points, which may easily cause waste of the bonding points and affect the precision of the adjustment on the display brightness.

### SUMMARY

The present disclosure is directed to solve at least one technical problem in the prior art, and provides a method and an apparatus for adjusting display brightness, and a display apparatus.

In a first aspect, an embodiment of the present disclosure provides a method for adjusting display brightness, the method includes: acquiring a plurality of first display brightness values input corresponding to a plurality of bonding points of a display panel; converting the plurality of first display brightness values into a plurality of second display brightness values according to a preset mapping relationship, and the plurality of second display brightness values are matched with a gamma adjustment curve; and adjusting the display brightness of the display panel by using the plurality of second display brightness values.

In some implementations, for any bonding point, the second display brightness value is greater than the first display brightness value.

In some implementations, for any bonding point, the second display brightness value is even times of the first display brightness value.

In some implementations, the second display brightness value between the bonding points adjacent to each other is calculated by interpolation.

In some implementations, the method further includes: before acquiring the plurality of first display brightness values input corresponding to the plurality of bonding points of the display panel, determining the number of the plurality of bonding points according to the number of bits corresponding to the second display brightness value.

In some implementations, the method further includes: after acquiring the plurality of first display brightness values input corresponding to the plurality of bonding points of the display panel, establishing the preset mapping relationship between the first display brightness values and the second display brightness values according to the number of bits corresponding to the first display brightness value and the number of bits corresponding to the second display brightness value.

In a second aspect, an embodiment of the present disclosure provides an apparatus for adjusting display brightness, the apparatus includes: a brightness value acquiring sub-circuit configured to acquire a plurality of first display brightness values input corresponding to a plurality of bonding points of a display panel; a converting sub-circuit configured to convert the plurality of first display brightness values into a plurality of second display brightness values according to a preset mapping relationship to make the plurality of second display brightness values be matched with a gamma adjustment curve; and an adjusting sub-circuit configured to adjust the display brightness of the display panel by using the plurality of second display brightness values.

In some implementations, the apparatus further includes: an interpolation sub-circuit configured to interpolate to calculate the second display brightness value between the bonding points adjacent to each other.

In some implementations, the apparatus further includes: a number determining sub-circuit configured to determine the number of the plurality of bonding points according to the number of bits corresponding to the second display brightness value.

In some implementations, the apparatus further includes: a mapping sub-circuit configured to establish the preset mapping relationship between the first display brightness values and the second display brightness values according to the number of bits corresponding to the first display brightness value and the number of bits corresponding to the second display brightness value.

In a third aspect, an embodiment of the present disclosure provides a display apparatus, the display apparatus includes the apparatus for adjusting display brightness provided as above.

In some implementations, the display apparatus further includes: a display brightness control circuit configured to input the first display brightness values to the display panel.

In some implementations, the display brightness control circuit is configured to perform a division operation by a bit-shift operation.

### BRIEF DESCRIPTION OF DRAWINGS

FIG. 1 is a schematic diagram of an exemplary gamma adjustment curve.

FIG. 2 is a schematic flowchart of a method for adjusting display brightness according to an embodiment of the present disclosure.

FIG. 3a is a diagram illustrating a correspondence between a first display brightness value and a second display brightness value.

FIG. 3b is another diagram illustrating a correspondence between a first display brightness value and a second display brightness value.

FIG. 4 is a schematic structural diagram of an apparatus for adjusting display brightness according to an embodiment of the present disclosure.

### DETAIL DESCRIPTION OF EMBODIMENTS

In order that those skilled in the art will better understand the technical solutions of the present disclosure, the following detailed description is given with reference to the accompanying drawings and the specific implementations.

Unless defined otherwise, technical or scientific terms used herein shall have the ordinary meaning as understood by one of ordinary skill in the art to which this disclosure belongs. The term “first”, “second” and the like in this disclosure is not intended to indicate any order, quantity, or importance, but rather is used to distinguish one element from another. Also, the term “a”, “an”, “the” or the like does not denote a limitation of quantity, but rather denotes the presence of at least one. The term “comprising/including”, “comprises/includes” or the like means that the element or item preceding the word includes the element or item listed after the word and its equivalent, but does not exclude other elements or items. The term “connected/connecting”, “coupled/coupling” or the like is not restricted to physical or mechanical connections, but may include electrical connections, whether direct or indirect. The terms “upper/on/above”, “lower/under/below”, “left”, “right”, or the like are used only to indicate relative positional relationships, and when the absolute position of the object being described is changed, the relative positional relationships may also be changed accordingly.

A display panel generally includes a pixel array in which a plurality of signal lines are intersected with each other, and pixel units are arranged in an array. Each pixel unit may include a light emitting element, a driving element, and a light emission control element. The light emitting element may be implemented as an organic light emitting diode or an inorganic light emitting diode, and the driving element and the light emission control element may be implemented as silicon-based transistors or oxide-based transistors. The driving element may be an internal compensation element having a driving characteristic that automatically compensates for, for example, a threshold voltage. The light emission control element may include a first light emission control element connected to an input terminal to which a high-level power supply voltage is input and a second light emission control element connected to the light emitting element. Each pixel unit may further include at least one switching element and a storage capacitor for reflecting a threshold voltage in a gate-source voltage of the driving element.

The pixel unit may include a red sub-pixel, a green sub-pixel, a blue sub-pixel, and a white sub-pixel. The color of light emitted by the pixel unit may be determined by a proportion of light emitted by the red sub-pixel, the green sub-pixel, the blue sub-pixel, and the white sub-pixel. Alternatively, the white sub-pixel may be cancelled from the pixel unit.

The apparatus for adjusting display brightness may receive a display brightness value input by a user, divide the display brightness into a plurality of different brightness levels, and adjust the display brightness of the display panel as desired by the user, so that the user can observe display pictures, with different brightness, displayed by the display panel in different environments, and the use experience of the user is improved. Typically, the display brightness value input by the user is represented by data of 12 bits, i.e., the display brightness value may range from 0 to 2¹², in the range from 0 to 2¹², there are 4096 display brightness values. Some of these display brightness values may be selected at intervals to represent the display brightness in a range, and the selected display brightness values are referred to as bonding points. For the display brightness value represented by the data of 12 bits, eight bonding points may be selected. The number of the bonding points selected for a driving chip is varied with the manufacturer of the driving chip. For example, in order to improve the accuracy of adjustment on the display brightness, the display brightness value may be represented by data of 13 bits, i.e., the display brightness value may range from 0 to 2¹³, and in the range from 0 to 2¹³, there are 8192 display brightness values. For the display brightness value represented by the data of 13 bits, seventeen bonding points may be selected to adjust the display brightness of the display panel.

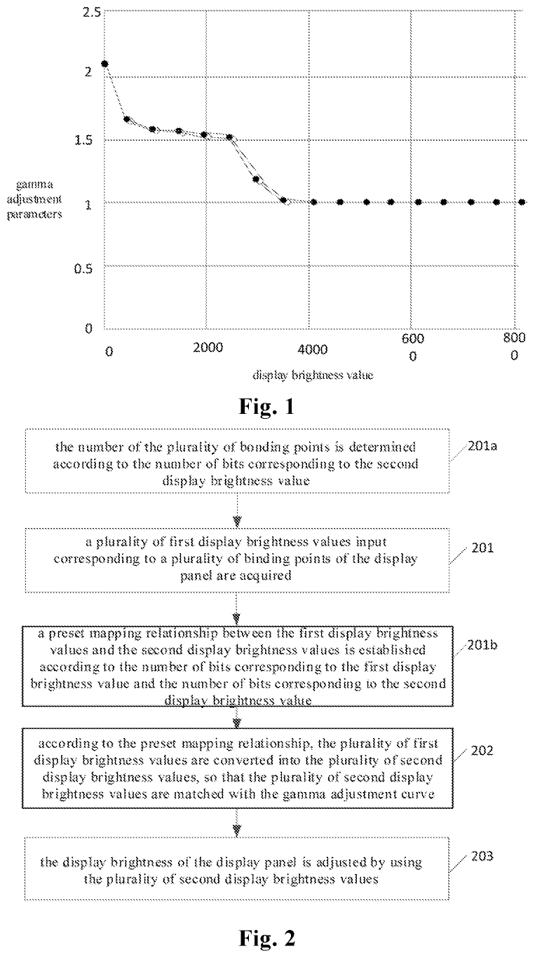

FIG. 1 is a schematic diagram of an exemplary gamma adjustment curve, as shown in FIG. 1, in the gamma adjustment curve, during adjusting using the display brightness value represent by the data of 13 bits, a part of the bonding points cannot be used, which is easy to cause waste of the bonding points and affects the accuracy of adjustment on the display brightness. Moreover, most of display panels currently produced only support to adjust the display brightness using the display brightness value represented by the data of 12 bits, the flexibility is poor, and the driving chip is to be specially designed for the display brightness value represented by the data of 12 bits, so that the flexibility is poor. Furthermore, the accuracy of adjustment on the display brightness is relatively low, and the use experience of the user is influenced.

In order to solve at least one of the above technical problems, embodiments of the present disclosure provide a method and an apparatus for adjusting display brightness, and a display apparatus, which are described in detail below.

In a first aspect, an embodiment of the present disclosure provides a method for adjusting display brightness, and FIG. 2 is a schematic flowchart of the method for adjusting display brightness provided in the embodiment of the present disclosure, and as shown in FIG. 2, the method for adjusting display brightness includes the following steps S201 to S203.

At the step S201, a plurality of first display brightness values input corresponding to a plurality of bonding points of a display panel are acquired.

In the step S201, the first display brightness values each may be represented by data of 12 bits, and generally, eight first display brightness values may be selected as the bonding points, however, in the embodiment of the present disclosure, in order to improve the accuracy of adjustment on the display brightness, more first display brightness values (for example, thirteen first display brightness values) may be selected as the bonding points. A difference between the first display brightness values corresponding to every two adjacent bonding points is 256. The first display brightness values corresponding to seventeen bonding points may sequentially be 0, 256, 512, 768, 1024, 1280, 1536, 1792, 2048, 2304, 2560, 2816, 3072, 3328, 3584, 3840, 4096. It is understood that the greater the number of the selected bonding points is, the greater the accuracy of adjustment on the display brightness is, and thus, as many bonding points as possible may be selected, but in view of the efficiency of adjustment on the display brightness, seventeen bonding points may be selected. Certainly, the number of the selected bonding points may be equal to any other value, which is not listed herein.

At the step S202, according to a preset mapping relationship, the plurality of first display brightness values are converted into a plurality of second display brightness values, so that the plurality of second display brightness values are matched with a gamma adjustment curve.

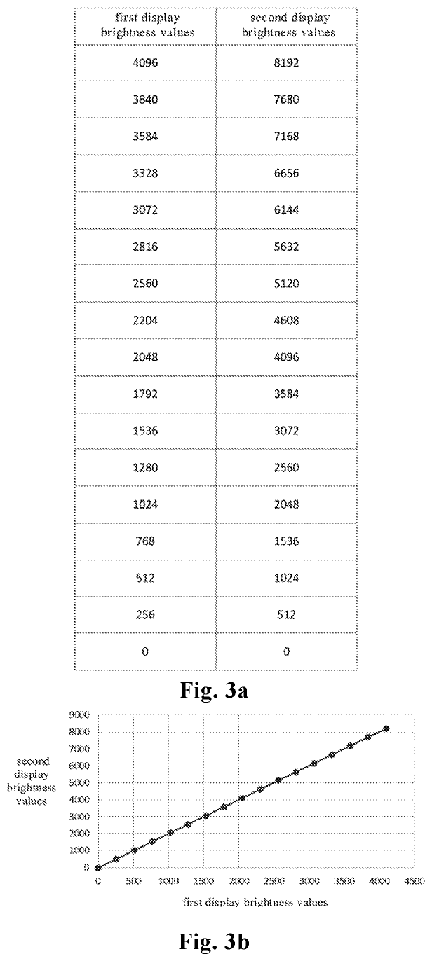

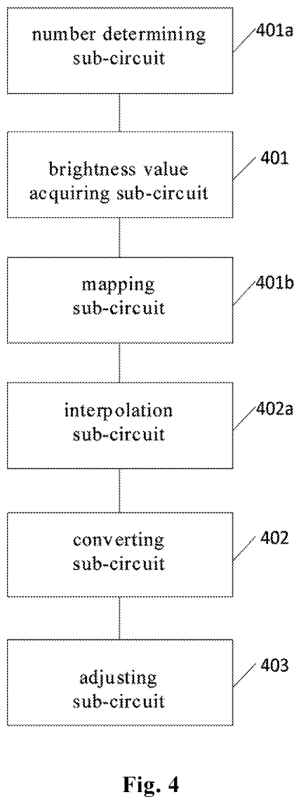

In the step S202, the second display brightness values each may be represented by data of 13 bits, i.e., the second display brightness value may range from 0 to 2¹³, and in the range from 0 to 2¹³, there are 8192 display brightness values. A mapping relationship between the first display brightness values and the second display brightness values may be established to convert the first display brightness values into the second display brightness values. For example, the first display brightness value is doubled to obtain the second display brightness value. The correspondence between the first display brightness values and the second display brightness values may be as shown in FIGS. 3a and 3b. In this way, the first display brightness value originally represented by the data of 12 bits can be converted into the second display brightness value represented by the data of 13 bits. In addition, a greater number of bonding points can be selected for adjusting the display brightness, and the second display brightness values are made to be matched with the gamma adjustment curve, so that the flexibility and the accuracy of adjustment on the display brightness are improved.

At the step S203, the display brightness of the display panel is adjusted by using the plurality of second display brightness values.

In the step S203, the display brightness of the display panel may be adjusted by using the second display brightness values obtained according to the preset mapping relationship, so as to avoid waste of bonding points.

In the method for adjusting display brightness provided by the embodiment of the present disclosure, the first display brightness values may be converted according to the preset mapping relationship to form the second display brightness values corresponding to the first display brightness values, the second display brightness values are matched with the gamma adjustment curve, and the display brightness of the display panel is adjusted by using the second display brightness values, so that one type of driving chips may be used to drive different types of display panels, and it is not necessary to design specific driving chips for different types of display panels, thereby improving the flexibility of adjusting the display brightness of the display panel. Furthermore, more bonding points can be selected in a certain display brightness range, so that the waste of the bonding points can be avoided, the accuracy of adjustment on the display brightness can be improved, the display panel would have more brightness levels, and the use experience of the user can be improved.

In some implementations, for any bonding point, the second display brightness value is greater than the first display brightness value.

In practical applications, for any bonding point, the second display brightness value is greater than the first display brightness value, to match the driving chip having a function of adjusting the display brightness with higher accuracy, and by adjusting the display brightness of the display panel utilizing the second display brightness values, the display panels of different types can be driven by one type of driving chips without specially designing the driving chips for the display panels of different types, and the flexibility of adjusting the display brightness of the display panel can be improved. In addition, more bonding points can be selected in a certain display brightness range, so that the waste of the bonding points can be avoided, the accuracy of adjustment on the display brightness can be improved, the display panel would have more brightness levels, and the use experience of the user is improved.

Specifically, for any bonding point, the second display brightness value is even times of the first display brightness value.

Since the display brightness value is a digital signal, and is represented by binary data, for example, the first display brightness values each may be represented by data of 12 bits, i.e., the first display brightness value may range from 0 to 2¹², and in the range from 0 to 2¹², there are 4096 display brightness values. The second display brightness values each may be represented by data of 13 bits, i.e., the second display brightness value may range from 0 to 2¹³, and in the range from 0 to 2¹³, there are 8192 display brightness values. Each first display brightness value may be converted by multiplying an even number to form the second display brightness value corresponding thereto. It is understood that the first display brightness value and the second display brightness value each may range from 0 to any other value, such as 2¹⁰, 2¹¹ and 2¹⁴, which are not listed herein.

In some implementations, the second display brightness value between the bonding points adjacent to each other is calculated by interpolation.

In order to ensure the uniformity of the display brightness of the display panel without any abrupt change during a display process, a line connecting all the display brightness values input into the display panel should be a smooth curve. In practical applications, only a part of the display brightness values are selected as the bonding points, for example, seventeen bonding points are selected, and other display brightness values can be calculated by adopting an interpolation method, so that the uniformity of the display brightness of the display panel is ensured, and the use experience of the user is prevented from being influenced.

In some implementations, as shown in FIG. 2, in the step S201, before the plurality of first display brightness values input corresponding to the plurality of bonding points of the display panel are acquired, the method further includes a step S201a, in which the number of the bonding points is determined according to the number of bits corresponding to the second display brightness value.

The second display brightness values each may be represented by data of 13 bits, i.e., the second display brightness value may range from 0 to 2¹³, and seventeen bonding points may be selected at an interval of 512. The number of the bonding points may be determined by the data type of the second display brightness value formed according to the preset mapping relationship to ensure that more bonding points can be uniformly distributed along the gamma adjustment curve, thereby ensuring the accuracy of adjustment on the display brightness and avoiding the waste of the bonding points.

In some implementations, as shown in FIG. 2, in the step S201, after the plurality of first display brightness values input corresponding to the plurality of bonding points of the display panel are acquired, the method further includes a step S201b, in which the preset mapping relationship between the first display brightness values and the second display brightness values is established according to the number of bits corresponding to the first display brightness value and the number of bits corresponding to the second display brightness value.

The first display brightness values each may be represented by the data of 12 bits, i.e., the first display brightness value may range from 0 to 2¹², and in the range from 0 to 2¹², there are 4096 display brightness values. The second display brightness values each may be represented by the data of 13 bits, i.e., the second display brightness value may range from 0 to 2¹³, and in the range from 0 to 2¹³, there are 8192 display brightness values. The first display brightness value may be multiplied with an even number to form the second display brightness value corresponding thereto, so as to form a correspondence as shown in FIG. 3a and FIG. 3b. It is understood that each of the first display brightness value and the second display brightness value may range from 0 to any other value, such as 2¹⁰, 2¹¹ and 2¹⁴, which are not listed herein.

In a second aspect, an embodiment of the present disclosure provides an apparatus for adjusting display brightness, and FIG. 4 is a schematic structural diagram of the apparatus for adjusting display brightness according to the embodiment of the present disclosure, as shown in FIG. 4, the apparatus for adjusting display brightness includes: a brightness value acquiring sub-circuit 401, a converting sub-circuit 402, an adjusting sub-circuit 403.

The brightness value acquiring sub-circuit 401 is configured to acquire a plurality of first display brightness values input corresponding to a plurality of bonding points of a display panel; the converting sub-circuit 402 is configured to convert the plurality of first display brightness values into a plurality of second display brightness values according to a preset mapping relationship, such that the plurality of second display brightness values are matched with a gamma adjustment curve; the adjusting sub-circuit 403 is configured to adjust the display brightness of the display panel by using the plurality of second display brightness values.

In the apparatus for adjusting display brightness provided by the embodiment of the present disclosure, the brightness value acquiring sub-circuit 401 may acquire the plurality of first display brightness values input corresponding to the plurality of bonding points of the display panel, and the converting sub-circuit 402 may convert the first display brightness values according to the preset mapping relationship to form the second display brightness values corresponding to the first display brightness values, the plurality of second display brightness values are matched with the gamma adjustment curve, and the adjusting sub-circuit 403 may utilize the second display brightness values to adjust the display brightness of the display panel, so that one type of driving chips may be used to drive different types of display panels, and it is not necessary to specially design driving chips for different types of display panels, thereby improving the flexibility of adjustment on the display brightness of the display panel. In addition, more bonding points can be selected in a certain display brightness range, so that the waste of the bonding points can be avoided, the accuracy of adjustment on the display brightness can be improved, the display panel would have more brightness levels, and the use experience of the user is improved.

In some implementations, the apparatus for adjusting display brightness further includes: an interpolation sub-circuit 402a configured to interpolate to calculate the second display brightness value between the bonding points adjacent to each other.

In order to ensure the uniformity of the display brightness of the display panel without any abrupt change during the display process, and a line connecting all the display brightness values input into the display panel should be a smooth curve. In practical applications, only a part of the display brightness values are selected as the bonding points, for example, seventeen bonding points are selected, and other display brightness values can be obtained by using the interpolation sub-circuit 402a to perform interpolation and calculation, so that the uniformity of the display brightness of the display panel is ensured, and the influence on the use experience of the user is avoided.

In some implementations, as shown in FIG. 4, the apparatus for adjusting display brightness further includes: a number determining sub-circuit 401a configured to determine the number of the bonding points according to the number of bits corresponding to the second display brightness value.

The second display brightness values each may be represented by data of 13 bits, i.e., the second display brightness value may range from 0 to 2¹³, and in the range from 0 to 2¹³, seventeen bonding points may be selected at an interval of 512. The number of the bonding points may be determined by the data type of the second display brightness values formed according to the preset mapping relationship to ensure that more bonding points can be uniformly distributed along the gamma adjustment curve, thereby ensuring the accuracy of adjustment on the display brightness and avoiding the waste of the bonding points.

In some implementations, the apparatus for adjusting display brightness further includes: a mapping sub-circuit 401b configured to establish the preset mapping relationship between the first display brightness values and the second display brightness values according to the number of bits corresponding to the first display brightness value and the number of bits corresponding to the second display brightness value.

The first display brightness values each may be represented by data of 12 bits, i.e., the first display brightness value may range from 0 to 2¹², and in the range from 0 to 2¹², there are 4096 display brightness values. The second display brightness values each may be represented by data of 13 bits, i.e., the second display brightness value may range from 0 to 2¹³, and in the range from 0 to 2¹³, there are 8192 display brightness values. The first display brightness value may be multiplied with an even number to form the second display brightness value corresponding to the first display brightness value, so as to form a corresponding relationship as shown in FIG. 3a and FIG. 3b. It is understood that each of the first display brightness value and the second display brightness value may range from 0 to any other value, such as 2¹⁰, 2¹¹ and 2¹⁴, which are not listed herein.

In a third aspect, an embodiment of the present disclosure provides a display apparatus, the display apparatus includes the apparatus for adjusting display brightness provided in the above embodiment, and the display apparatus may be a terminal device such as a mobile phone, a tablet computer, a notebook computer, a smart television, and an implementation principle of the display apparatus is the same as that of the method for adjusting display brightness provided in the above embodiment, and is not repeated here.

In some implementations, the display apparatus further includes: a display brightness control circuit configured to input a first display brightness value to the display panel. The display brightness control circuit performs a division operation by a bit-shift operation.

In the display apparatus provided by the embodiment of the present disclosure, the display brightness control circuit may provide the first display brightness values to the display panel, and the division operation is to be performed in the display brightness control circuit, but the division operation may result in a relatively high power consumption during an operation process, and thus the division operation may be replaced by the bit-shift operation, so that the division operation is not to be performed, and thus, the power consumption of the display apparatus can be reduced, and the cost is saved. In practical applications, a shift to right in the bit-shift operation represents a division operation, a shift of one bit to right represents a division operation by 2, and a shift of n bits to right represents a division operation by 2ⁿ.

It will be understood that the above embodiments are merely exemplary embodiments employed to illustrate the principles of the present disclosure, and the present disclosure is not limited thereto. It will be apparent to those skilled in the art that various changes and modifications can be made without departing from the spirit and scope of the present disclosure, and these changes and modifications are to be considered within the scope of the present disclosure.

1. A method for adjusting display brightness, comprising:
acquiring a plurality of first display brightness values input corresponding to a plurality of bonding points of a display panel;
converting the plurality of first display brightness values into a plurality of second display brightness values according to a preset mapping relationship, and the plurality of second display brightness values are matched with a gamma adjustment curve; and
adjusting the display brightness of the display panel by using the plurality of second display brightness values.

2. The method according to claim 1, wherein for any bonding point, the second display brightness value is greater than the first display brightness value.

3. The method according to claim 2, wherein for any bonding point, the second display brightness value is even times of the first display brightness value.

4. The method according to claim 1, wherein any second display brightness value between the bonding points adjacent to each other is calculated by interpolation.

5. The method according to claim 1, further comprising: before acquiring the plurality of first display brightness values input corresponding to the plurality of bonding points of the display panel,
determining a total number of the plurality of bonding points according to a total number of bits corresponding to the second display brightness value.

6. The method according to claim 1, further comprising: after acquiring the plurality of first display brightness values input corresponding to the plurality of bonding points of the display panel,
establishing the preset mapping relationship between the first display brightness values and the second display brightness values according to a total number of bits corresponding to the first display brightness value and a total number of bits corresponding to the second display brightness value.

7. An apparatus for adjusting display brightness, comprising:
a brightness value acquiring sub-circuit configured to acquire a plurality of first display brightness values input corresponding to a plurality of bonding points of a display panel;
a converting sub-circuit configured to convert the plurality of first display brightness values into a plurality of second display brightness values according to a preset mapping relationship to make the plurality of second display brightness values to be matched with a gamma adjustment curve; and
an adjusting sub-circuit configured to adjust the display brightness of the display panel by using the plurality of second display brightness values.

8. The apparatus according to claim 7, further comprising:
an interpolation sub-circuit configured to interpolate to calculate any second display brightness value between the bonding points adjacent to each other.

9. The apparatus according to claim 7, further comprising:
a number determining sub-circuit configured to determine a total number of the plurality of bonding points according to a total number of bits corresponding to the second display brightness value.

10. The apparatus according to claim 7, further comprising:
a mapping sub-circuit configured to establish the preset mapping relationship between the first display brightness values and the second display brightness values according to a total number of bits corresponding to the first display brightness value and a total number of bits corresponding to the second display brightness value.

11. A display apparatus, comprising the apparatus for adjusting display brightness according to claim 7.

12. The display apparatus according to claim 11, further comprising:
a display brightness control circuit configured to input the first display brightness values to the display panel.

13. The display apparatus according to claim 12, wherein the display brightness control circuit performs a division operation by a bit-shift operation.

14. A display apparatus, comprising the apparatus for adjusting display brightness according to claim 8.

15. The display apparatus according to claim 14, further comprising:
a display brightness control circuit configured to input the first display brightness values to the display panel.

16. The display apparatus according to claim 15, wherein the display brightness control circuit performs a division operation by a bit-shift operation.

17. A display apparatus, comprising the apparatus for adjusting display brightness according to claim 9.

18. The display apparatus according to claim 17, further comprising:
a display brightness control circuit configured to input the first display brightness values to the display panel.

19. The display apparatus according to claim 18, wherein the display brightness control circuit performs a division operation by a bit-shift operation.

20. A display apparatus, comprising the apparatus for adjusting display brightness according to claim 10.
